(19) United States
(12) Patent Application Publication
(10) Pub. No.: US 2006/0010919 A1
(43) Pub. Date: Jan. 19, 2006

(54) Molding core

(75) Inventor: Kun-Chih Wang, Taichung (TW)

Correspondence Address: DLA PIPER RUDNICK GRAY CARY US, LLP, 2000 UNIVERSITY AVENUE, E. PALO ALTO, CA, 94303-2248, US

(73) Assignee: Asia Optical Co., Inc.

(21) Appl. No.: 11/176,807

(22) Filed: Jul. 6, 2005

(30) Foreign Application Priority Data
Jul. 14, 2004 (TW) 093120982

(51) Int. Cl. C03B 11/06

(52) U.S. Cl. 65/374.13; 65/374.15

(57) ABSTRACT

A molding core includes: a core body having an article-shaping surface; an intermediate film formed on the article-shaping surface of the core body and including a first composite layer that contains carbon, nitrogen, and at least one bonding-enhancing element which is selected from silicon, titanium, aluminum, tungsten, tantalum, chromium, zirconium, vanadium, niobium, hafnium, and boron, and which forms covalence bonding with the carbon and the nitrogen; and a hard coating that includes a carbon film formed on the intermediate film.

### CROSS-REFERENCE TO RELATED APPLICATION

This application claims priority of Taiwanese Application No. 093120982, filed on Jul. 14, 2004.

### BACKGROUND OF THE INVENTION

1. Field of the Invention

This invention relates to a molding core, more particularly to a molding core with a composite layer that comprises carbon, nitrogen, and a bonding-enhancing element which forms covalence bonding with the carbon and the nitrogen.

2. Description of the Related Art

FIG. 1 illustrates a conventional molding core for a press-molding mold that is used for press molding of a glass perform 13 into an optical lens article. The conventional molding core includes a core body 11 and a protective film 12 formed on an article-shaping surface of the core body 11. Conventionally, the protective film 12 is made from a diamond-like carbon (DLC) structure. However, DLC tends to deteriorate due to oxidation or precipitation of undesired materials at the surface thereof under high working temperatures, which results in roughening of the surface thereof, which, in turn, results in poor quality of the molded products. Moreover, the bonding strength between the DLC structure and the core body 11 decreases gradually after a period of use, which can result in peeling of the protective film 12 from the core body 11.

JP 9-227150 discloses a method for making a molding core that includes the steps of forming a DLC film on a core body, implanting nitrogen ions into the DLC film using ion implantation techniques, and subsequently subjecting the DLC film to a heating treatment under a nitrogen atmosphere so as to form covalence bonding between carbon and nitrogen in the DLC film and so as to enhance chemical stability of the DLC film. However, the improvement in the bonding strength between the DLC film and the core body is limited, and there is still a need to enhance the boding strength between the DLC film and the core body. Moreover, there is also a need to further enhance the chemical stability of the DLC film.

### SUMMARY OF THE INVENTION

The object of the present invention is to provide a molding core that is capable of overcoming the aforesaid drawbacks of the prior art.

According to this invention, there is provided a molding core useful for molding a glass. The molding core comprises: a core body having an article-shaping surface; an intermediate film formed on the article-shaping surface of the core body and including a first composite layer that comprises carbon, nitrogen, and at least one bonding-enhancing element which is selected from the group consisting of Silicon, Titanium, Aluminum, Tungsten, Tantalum, Chromium, Zirconium, Vanadium, Niobium, Hafnium, and Boron, and which forms covalence bonding with the carbon and the nitrogen; and a hard coating that includes a carbon film formed on the intermediate film.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a schematic view of a conventional molding core; and

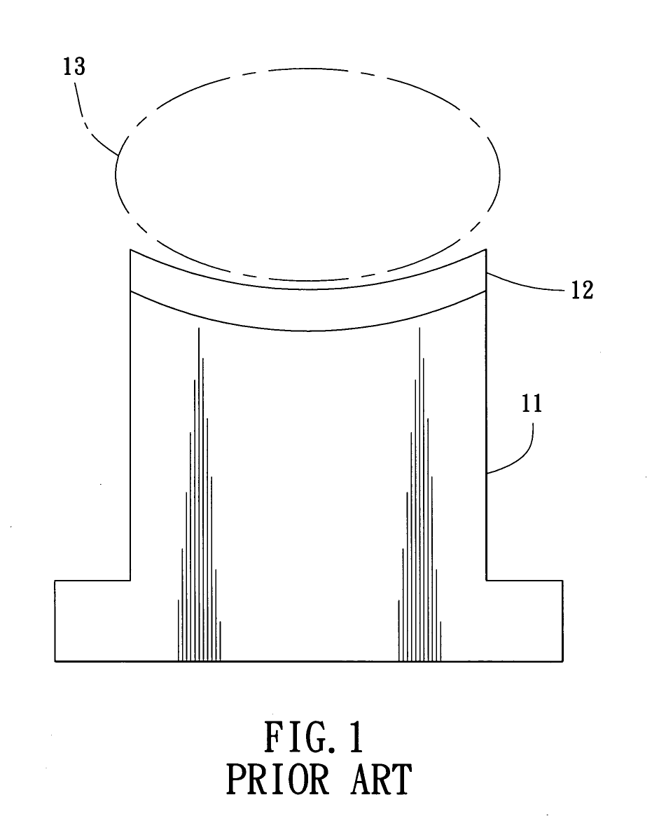

FIG. 2 is a schematic view of the preferred embodiment of a molding core according to this invention.

### DETAILED DESCRIPTION OF THE PREFERRED EMBODIMENT

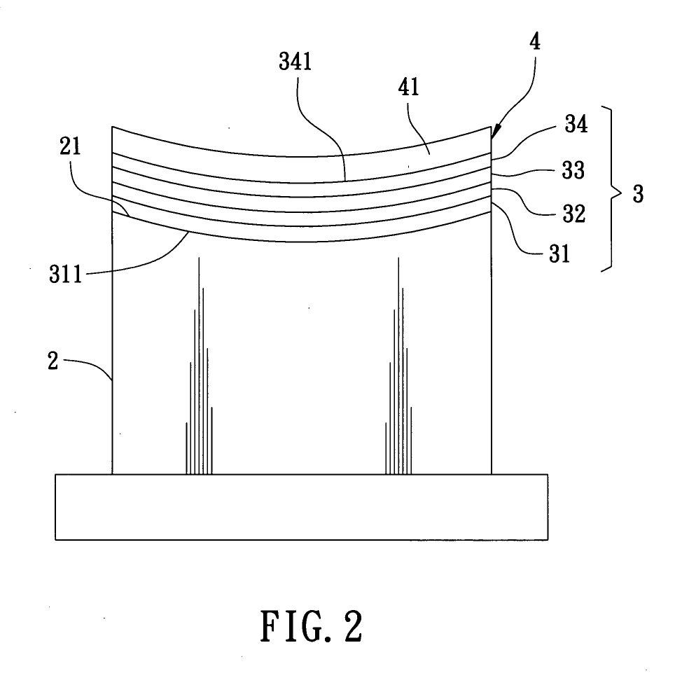

FIG. 2 illustrates the preferred embodiment of a molding core used in a press-molding mold (not shown) for making optical lens articles according to the present invention.

The molding core includes: a core body 2 having an article-shaping surface 21; an intermediate film 3 formed on the article-shaping surface 21 of the core body 2 and including a first composite layer 33 that comprises carbon, nitrogen, and at least one bonding-enhancing element which is selected from the group consisting of silicon, titanium, aluminum, tungsten, tantalum, chromium, zirconium, vanadium, niobium, hafnium, and boron, and which forms covalence bonding with the carbon and the nitrogen; and a hard coating 4 that includes a carbon film 41 formed on the intermediate film 3.

Preferably, the intermediate film 3 further includes a second composite layer 32 that is sandwiched between the core body 2 and the first composite layer 33 and that comprises carbon and the bonding-enhancing element which forms covalence bonding with the carbon in the second composite layer 32, an amorphous layer 31 of the bonding-enhancing element that is sandwiched between the core body 2 and the second composite layer 32, and an amorphous carbon layer 34 that is sandwiched between the carbon film 41 of the hard coating 4 and the first composite layer 33.

The core body 2 is preferably made from a material selected from the group consisting of tungsten carbide, silicon carbide, and silicon nitride, and is more preferably made from tungsten carbide.

Preferably, the bonding-enhancing element is silicon, the first composite layer 33 includes crystalline nano-particles of silicon carbide and crystalline nano-particles of silicon nitride dispersed therein, the second composite layer 32 includes crystalline nano-particles of silicon carbide dispersed therein, and the amorphous carbon layer 31 includes nano-particles of a nitride compound dispersed therein.

In this embodiment, the carbon film 41 of the hard coating 4 is a diamond-like carbon film which comprises carbon and nitrogen.

Preferably, each of the first and second composite layers 33, 32, the amorphous layer 31 of the bonding-enhancing element, and the amorphous carbon layer 34 has a thickness ranging from 10 to 50 nm.

Formation of the intermediate film 3 is conducted by supplying a carbon-containing source, a nitrogen-containing source, a hydrogen-containing source, and a bonding-enhancing element-containing source to a reaction chamber (not shown).

The bonding-enhancing element-containing source is preferably a silicon-containing material selected from the group consisting of solid silicon, Si₃N₄, and silanes, such as SiH₄.

The carbon-containing source is preferably a hydrocarbon group having from 1 to 6 carbon atoms, and is preferably selected from the group consisting of methane, ethylene, acetylene, and combinations thereof.

The hydrogen source is a hydrogen-containing material selected from the group consisting of hydrogen, SiH₄, methane, ethylene, and acetylene.

Acetylene can be used as a source for each of the carbon-containing source and the hydrogen-containing source.

### EXAMPLE

This invention will now be described in greater detail with reference to the following Example.

### Example 1

The core body 2 employed in this Example was made from tungsten carbide. The bonding-enhancing element used in this Example is silicon. The amorphous layer 31 of the silicon was formed by sputtering techniques using a chamber (not shown) that was evacuated to a base pressure of 5×10⁻⁴ Pa and that was controlled at a deposition temperature of 350° C. Ar gas was then introduced into the chamber, and the pressure was controlled to 3×10⁻¹ Pa. High frequency (RF) power of 500W was applied to the chamber to bombard a silicon target with a purity of 99.999% for forming a thickness of 10 nm of the amorphous layer 31 on the core body 2.

The second composite layer 32 was formed by reactive ion sputtering techniques by introducing Ar and acetylene gases into the chamber in a mass flow rate ratio of 2:1 (Ar:acetylene) and by controlling the pressure to 5×10⁻¹ Pa. High frequency (RF) power of 500W was applied to the chamber to bombard the silicon target under a deposition temperature of 350° C. for forming a thickness of 10 nm of the second composite layer 32 on the amorphous layer 31.

The first composite layer 33 was formed by reactive ion sputtering techniques by introducing Ar, nitrogen, and acetylene gases into the chamber in a mass flow rate ratio of 4:1:1 (Ar:nitrogen:acetylene) and by controlling the pressure to 5×10⁻¹ Pa. High frequency (RF) power of 500W was applied to the chamber to bombard the silicon target under a deposition temperature of 350° C. for forming a thickness of 10 nm of the first composite layer 33 on the second composite layer 32.

The amorphous carbon layer 34 was formed by ion plating techniques by introducing nitrogen and acetylene gases into the chamber in a mass flow rate ratio of 1:2 (nitrogen:acetylene) and by controlling the pressure to 2×10⁻¹ Pa. A self-biased voltage of 2.5 kV was produced in the core body 2 (substrate). The plating was conducted at a working temperature of 300° C. so as to form a thickness of 20 nm of the amorphous carbon layer 34 on the first composite layer 33.

The carbon film 41 of the hard coating 4 was formed by ion plating by introducing nitrogen and acetylene gases into the chamber in amass flow rate ratio of 1:12 (nitrogen:acetylene). The ion plating was conducted at a pressure of 1×10⁻¹ Pa and a working temperature of 300° C. so as to form a thickness of 100 nm of the carbon film 41 on the amorphous carbon flayer 34.

After formation of the carbon film 41, the molding core was subjected to heat treatment (annealing) under a pressure of 2×10⁻³ Torr and a temperature of 610° C. for three hours so as to increase formation of the crystalline nano-particles of the silicone carbide and the crystalline nano-particles of the silicon nitride.

The molding core prepared by Example 1 and a conventional molding core which was formed with a conventional DLC film were subjected to peeling testing. The results show that the molding core of this invention can be used in press molding over 10000 times, while the molding surface of the conventional molding core became damaged as peeling of the DLC film was observed after being in use for 500 times.

In addition, formation of the intermediate film 3 can be controlled in a manner such that the concentration of the bonding-enhancing element in the intermediate film 3 is gradually decreased from a first side 311 of the intermediate film 3, which is connected to the core body 2, to a second side 341 of the intermediate film 3, which is opposite to the first side 311 and which is connected to the carbon film 41 of the hard coating 4, i.e., the concentration of the bonding-enhancing element is gradually decreased from the amorphous layer 31 to the amorphous carbon layer 34.

By virtue of the presence of the intermediate film 3 in the molding core of this invention, the aforesaid drawbacks associated with the prior art can be eliminated.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

I claim:

1. A molding core useful for molding a glass, comprising:
a core body having an article-shaping surface;
an intermediate film formed on said article-shaping surface of said core body and including a first composite layer that comprises carbon, nitrogen, and at least one bonding-enhancing element which is selected from the group consisting of silicon, titanium, aluminum, tungsten, tantalum, chromium, zirconium, vanadium, niobium, hafnium, and boron, and which forms covalence bonding with the carbon and the nitrogen; and
a hard coating that includes a carbon film formed on said intermediate film.

2. The molding core of claim 1, wherein said intermediate film has a first side that is connected to said core body, and a second side that is opposite to said first side, the concentration of said bonding-enhancing element in said intermediate film being gradually decreased from said first side to said second side of said intermediate film.

3. The molding core of claim 2, wherein said intermediate film further includes a second composite layer that is sandwiched between said core body and said first composite layer and that comprises carbon and said bonding-enhancing element which forms covalence bonding with the carbon in said second composite layer.

4. The molding core of claim 3, wherein said intermediate film further includes an amorphous layer of said bonding-enhancing element that is sandwiched between said core body and said second composite layer.

5. The molding core of claim 4, wherein said intermediate film further includes an amorphous carbon layer that is sandwiched between said carbon film of said hard coating and said first composite layer.

6. The molding core of claim 5, wherein said bonding-enhancing element is silicon.

7. The molding core of claim 6, wherein said second composite layer includes crystalline nano-particles of silicon carbide dispersed therein.

8. The molding core of claim 6, wherein said first composite layer includes crystalline nano-particles of silicon carbide and crystalline nano-particles of silicon nitride dispersed therein.

9. The molding core of claim 5, wherein said amorphous carbon layer includes nano-particles of a nitride compound dispersed therein.

10. The molding core of claim 5, wherein said amorphous carbon layer has a thickness ranging from 10 to 50 nm.

11. The molding core of claim 4, wherein said amorphous layer of said bonding-enhancing element has a thickness ranging from 10 to 50 nm.

12. The molding core of claim 3, wherein said second composite layer has a thickness ranging from 10 to 50 nm.

13. The molding core of claim 1, wherein said carbon film of said hard coating is a diamond-like carbon film which comprises carbon and nitrogen.

14. The molding core of claim 13, wherein said diamond-like carbon film has a thickness ranging from 50 to 500 nm.

15. The molding core of claim 1, wherein said core body is made from a material selected from the group consisting of tungsten carbide, silicon carbide, and silicon nitride.

16. The molding core of claim 1, wherein said first composite layer has a thickness ranging from 10 to 50 nm.

17. A molding core useful for molding a glass, comprising:
a core body;
an intermediate film formed on said core body, having a first side that is connected to said core body and a second side that is opposite to said first side, and including a first composite layer that comprises carbon, nitrogen, and at least one bonding-enhancing element which is selected from the group essentially consisting of silicon, titanium, aluminum, tungsten, tantalum, chromium, zirconium, vanadium, niobium, hafnium, and boron; and
a hard coating formed on said intermediate film;
wherein the concentration of said bonding-enhancing element in said intermediate film is gradually decreased from said first side to said second side of said intermediate film.

18. The molding core of claim 17, wherein said intermediate film further includes a second composite layer that is sandwiched between said core body and said first composite layer and that comprises carbon and said bonding-enhancing element which forms covalence bonding with the carbon in said second composite layer.

19. The molding core of claim 18, wherein said intermediate film further includes an amorphous layer of said bonding-enhancing element that is sandwiched between said core body and said second composite layer.

20. The molding core of claim 19, wherein said intermediate film further includes an amorphous carbon layer that is sandwiched between said carbon film of said hard coating and said first composite layer.
